(19) United States
(12) Patent Application Publication
(10) Pub. No.: US 2007/0067400 A1
(43) Pub. Date: Mar. 22, 2007

(54) User matching server, user matching method and user matching program

(75) Inventors: Nobuo Kawakami, Tokyo (JP); Makoto Nakano, Tokyo (JP)

Correspondence Address: GREENBLUM & BERNSTEIN, P.L.C., 1950 ROLAND CLARKE PLACE, RESTON, VA, 20191, US

(73) Assignee: Dwango Co., Ltd., Tokyo (JP)

(21) Appl. No.: 11/239,091

(22) Filed: Sep. 30, 2005

(30) Foreign Application Priority Data
Sep. 16, 2005 (JP) 2005-269424
Sep. 28, 2005 (JP) 2005-282773

(51) Int. Cl. G06F 15/16

(52) U.S. Cl. 709/206

(57) ABSTRACT

When a matching condition is accepted, a memory is searched to find a user ID that corresponds to an email address for the portable terminal that is the access source, and a temporary email address corresponding to the user ID is generated. Then, the temporary email address is registered in the memory in correlation with the corresponding user ID, and in accordance with the matching conditions, matching is performed for the user ID that is found. In accordance with the matching results, the temporary email address stored in the memory is employed to exchange an email with the portable terminal at the access source.

The present disclosure relates to subject matter contained in Japanese Patent Application No. 2005-269424, filed on Sep. 16, 2005, and Japanese Patent application No. 2005-282773, filed on Sep. 28, 2005, the disclosures of which are expressly incorporated herein by reference in their entirety.

### BACKGROUND OF THE INVENTION

1. Field of the Invention

The present invention relates to a user matching server that employs the email function of a terminal device, such as a cellular phone, to pair users having like hobbies and interests, as they may so desire, and a user matching method and a user matching program.

2. Description of the Related Art

Conventionally, a system is available that employs a Web for matching users who have like hobbies and interests. According to this system, when a user desires to receive an invitation to enter into a web based relationship with a like-minded person, the user can employ a predetermined registration form, for example, to register user information that will be published on the Web. Then, when another individual who desires to initiate a relationship with a like-minded person employs a search system and finds the user's registered information on the Web, that individual can contact the user.

As such a system for matching users who have like hobbies and interests, a person-to-person, go-between computer network is proposed in Japanese Patent Laid-Open Publication No. 1994-19926. According to this computer network, the computer terminal of each user who is searching for a desirable person includes a registration unit for the registration of user data and desired data. A suitable person list preparation unit compares the registered desired data with partner data, and displays, on a display screen, a list of possibly suitable persons. Then, a user can select a specific person from the displayed list and, using a character symbol data transmission/reception unit, a speech data transmission/reception unit or an image data transmission/reception unit, can transmit to the computer terminal of that person, via a data transfer network, a message that includes a character symbol, speech or an image. If possible, contact with the specific person may be effected by engaging in a dialogue in real time.

According to the technique disclosed in Japanese Patent Laid-Open Publication No. 1994-19926, the registered desired data are compared with partner data, and a list of possibly suitable partners is displayed on the display unit. Therefore, it is believed there is a high probability that a desired correspondent can be found without an excessive expenditure of effort and cost.

However, it is very difficult for this Web based system to be provided for cellular phones. Because the specifications for the Web functions of cellular phones vary, depending on the cellular phone companies, a so-called terminal dependency influence can adversely affect transmissions, e.g., appropriate screen displays can not be transmitted between cellular phones that are contracted out by different cellular phone companies.

This problem can also occur, though only slightly, between cellular phones contracted out by the same cellular phone company. That is, the displays can be is changed, depending on the makers of the cellular phones.

On the other hand, even though cellular phones may be contracted out by different cellular phone companies, the email functions themselves are not affected by the above described terminal dependency, and it is thus believed that user matching can be performed by employing the email function.

An email address representing a transmission source is requisite for the use of the email function. In this case, however, since an email address represents personal information, or is extremely near being personal information, a user is reluctant to immediately provide an email address for an unknown person.

In this case, there would be no problem if an email address that differs from a primary address (an email address that can be used under a contract entered into with a cellular phone company) could be employed, and could be disposed of when no longer required. However, such a temporary email address, which would differ from a primary address, is not provided in consonance with the purpose for which it would be employed by a user.

Further, there is no system that provides, for a user, a temporary email address that differs from a primary address and does not require that an operation be performed by the user.

### SUMMARY OF THE INVENTION

While taking the above described situation into account, the objectives of the present invention are the provision of a user matching server, which permits users to exchange email using temporary email addresses without being aware that temporary email addresses are being used and without user labor being required, and a user matching method and a user matching program.

According to the present invention, a user matching server, for controlling portable terminals and perform the matching of users, comprises:

a storage unit, for storing email addresses of users in correlation with user IDs;

an acceptance unit, for accepting at least one matching condition received by email from a portable terminal;

a search unit, for, when at least one matching condition is received by the acceptance unit, searching the storage unit to find a user ID corresponding to an email address for a portable terminal that is an access source for the matching condition;

a generation unit, for, when the search unit has found the user ID, generating a temporary email address corresponding to the user ID;

a registration unit, for registering, in the storage unit, the temporary email address generated by the generation unit in correlation with the user ID corresponding to the temporary email address;

a matching unit, for referring to the storage unit and performing matching, in accordance with the matching condition accepted by the acceptance unit, for the user ID found by the search unit; and

an email communication unit, for, in accordance with the matching results obtained by the matching unit, employing the temporary email address stored in the storage unit to exchange email with the portable terminal at the access source.

A use period may be designated for the temporary email address registered by the registration unit.

The user matching server may further comprise:

a matching condition storage unit, for storing paired matching conditions.

According to the present invention, a user matching method, for a server that controls portable terminals and performs the matching of users, comprises:

accepting at least one matching condition transmitted by email by a portable terminal;

when at least one matching condition is accepted examining a memory provided for the server wherein email addresses of users are stored in correlation with user IDs, and of searching for a user ID corresponding to an email address of a portable terminal that is an access source for the matching condition;

when the user ID is found, generating a temporary email address corresponding to the user ID;

registering, in the memory, the temporary email address generated in correlation with the user ID corresponding to the temporary email address;

referring to the memory and of performing matching for the user ID found in accordance with the matching condition accepted; and

in accordance with the matching results obtained employing the temporary email address stored in the memory to exchange an email with the portable terminal at the access source.

The user matching method may further comprise:

designating a use period for the temporary email address registered.

The user matching method may further comprise storing paired matching conditions.

According to the present invention, a user matching program, executable by a computer of a server that controls portable terminals and performs the matching of users, permits the computer to perform:

accepting at least one matching condition transmitted by email by a portable terminal;

when at least one matching condition is accepted examining a memory provided for the server wherein email addresses of users are stored in correlation with user IDs, and of searching for a user ID corresponding to an email address of a portable terminal that is an access source for the matching condition;

when the user ID is found, generating a temporary email address corresponding to the user ID;

registering, in the memory, the temporary email address generated in correlation with the user ID corresponding to the temporary email address;

referring to the memory and of performing matching for the user ID found in accordance with the matching condition accepted; and

in accordance with the matching results obtained employing the temporary email address stored in the memory to exchange an email with the portable terminal at the access source.

The user matching program may permit the computer to perform:

designating a use period for the temporary email address registered.

The user matching program may permit the computer to perform storing paired matching conditions.

According to the user matching server, the user matching method and the user matching program, when a matching condition is accepted, a memory is searched to find a user ID that corresponds to an email address of the portable terminal that is the access source, and a temporary email address corresponding to the user ID is generated. Then, the temporary email address is registered in the memory in correlation with the corresponding user ID, and in accordance with the matching condition, matching is performed for the user ID that is found. In accordance with the matching results, the temporary email address stored in the memory is employed for the exchange of email with the portable terminal at the access source. Therefore, the users can exchange email using temporary email addresses, without being aware of the temporary email addresses and without their labor being required.

### BRIEF DESCRIPTION OF THE DRAWINGS

FIG. 1 is a diagram showing a user matching system according to one embodiment of the present invention;

FIG. 2 is a diagram for explaining an overview of the user matching system in FIG. 1;

FIG. 3 is a detailed block diagram for explaining a user matching processor in FIG. 1;

FIG. 4 is a diagram for explaining a keyword extraction table referred to by an email content analysis unit in FIG. 3;

FIG. 5 is a detailed diagram for explaining a database in FIG. 1;

FIG. 6 is a flowchart for explaining the user registration processing performed by the user matching system in FIG. 1;

FIG. 7 is diagram for explaining the user registration processing performed by the user matching system in FIG. 1;

FIG. 8 is a flowchart for explaining the schedule registration processing performed by the user matching system in FIG. 1;

FIG. 9 is a flowchart for explaining the user list acquisition processing performed by the user matching system in FIG. 1;

FIG. 10 is a flowchart for explaining the processing performed by the user matching system in FIG. 1 for transmitting an email addressed to a temporary email address; and

FIG. 11 is a flowchart for explaining the “from” replacement processing performed by the user matching system in FIG. 10.

### DESCRIPTION OF THE EMBODIMENTS

According to one embodiment of the present invention, when at least one matching condition (i.e., a registration condition or a request condition is accepted, a memory is searched to find a user ID that corresponds to an email address of the portable terminal that is the access source, and a temporary email address corresponding to the user ID is generated. Then, the temporary email address is registered in the memory in correlation with the corresponding user ID, and in accordance with the at least one matching condition, matching is performed for the user ID that is found. In accordance with the matching results, the temporary email address stored in the memory is employed for the exchange of email with the portable terminal at the access source. Therefore, the users can exchange email using temporary email addresses, without being aware of the temporary email addresses and without their labor being required.

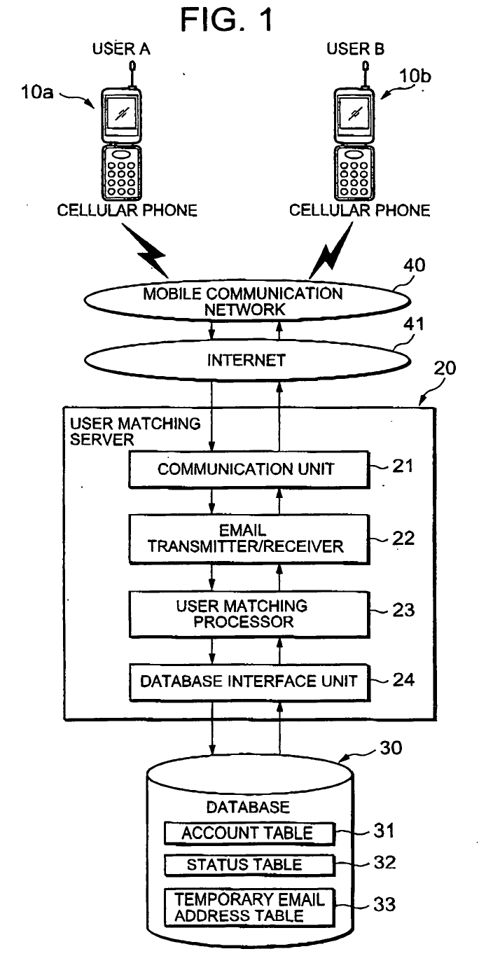

FIG. 1 is a diagram showing a user matching system according to one embodiment of the present invention. In the following explanation, a temporary email address means an anonymous email address that is available for temporary use or for disposable use. Further, a primary email address is an email address that is designated in advance for a cellular phone and is employed under a contract entered into with a communication carrier (a company that provides a communication service).

The user matching system in FIG. 1 includes cellular phones 10a and 10b, a user matching server 20 and a database 30.

The cellular phones 10a and 10b are portable terminals that can communicate with the user matching server 20 via a mobile communication network 40 provided by each communication carrier and the Internet 41. In this embodiment, assume that, at the least, an email function is mounted in the cellular phones 10a and 10b, and that a user A employs the cellular phone 10a and a user B employs the cellular phone 10b. The portable terminals are not limited to the cellular phones 10a and 10b, and other devices, such as PDAs, may be used.

The user matching server 20 is managed by a provider that provides services to naturally bring together users who have like hobbies and interests in accordance with their desires. The user matching server 20 includes a communication unit 21, an email transmitter/receiver 22, a user matching processor 23 and a database interface unit 24.

The communication unit 21 performs packet communication with the cellular phones 10a and 10b via the Internet 41. The email transmitter/receiver 22 exchanges email, and upon receiving an email inquiry, transmits to the requesting user a list on which users having like hobbies and interests are linked in accordance with their desires. In this case, temporary email addresses that differ from the primary email addresses of the users (email addresses used under contracts entered into with cellular phone companies) are entered in the list.

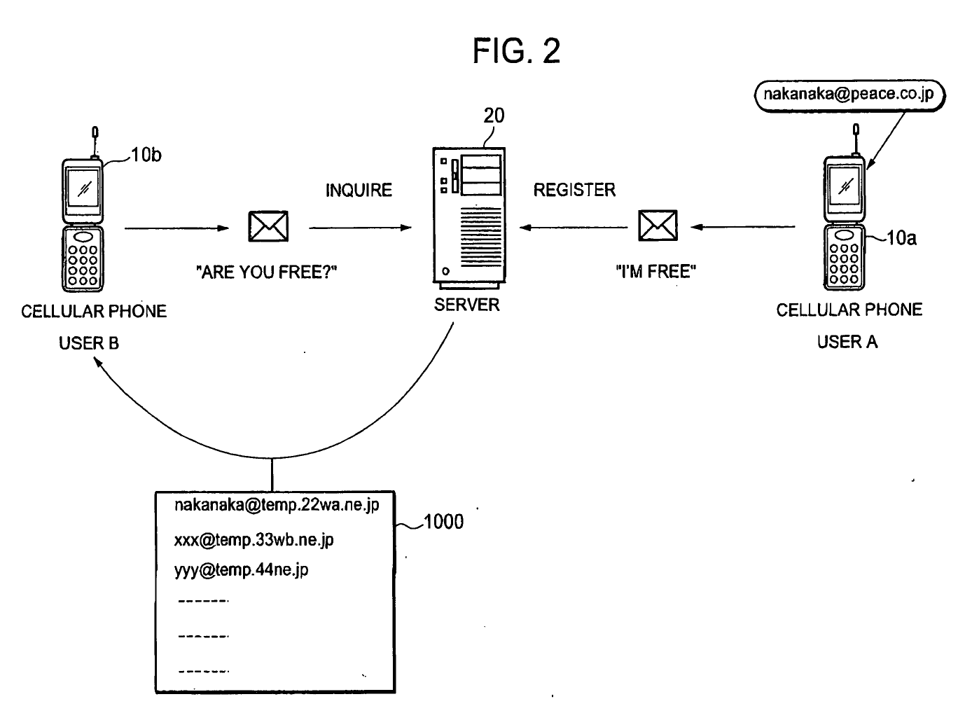

For example, as shown in FIG. 2, assume that the user A who has completed the user registration employs the cellular phone 10a, and transmits an email to the user matching server 20 requesting registration of a predetermined registration condition of, for example, “I'm free.” that indicates the user is waiting for invitation and that the user matching server 20 has registered this condition. Then, the user B, who has completed user B processing, uses the cellular phone 10b to transmit an email to the user matching server 20 that includes, as an inquiry, a predetermined request condition of, for example, “Are you free?” that indicates the desire to issue an invitation.

The user matching server 20 performs the matching process based on the content “free”, and transmits an email containing a list 1000 of matching users to the inquiring user B. In this case, temporary email addresses are entered in the user list 1000.

The user matching processor 23 performs user matching in accordance with the contents of the registration requesting email received from the user who completed the user registration and the contents of the inquiring email. The user matching processing will be described in detail later.

In accordance with an instruction transmitted by the user matching processor 23, the database interface unit 24, transmits to the database 30 information to be registered, or receives registered information from the database 30.

The database 30 includes an account table 31, a status table 32 and a temporary email address table 33, all of which will be explained in detail later.

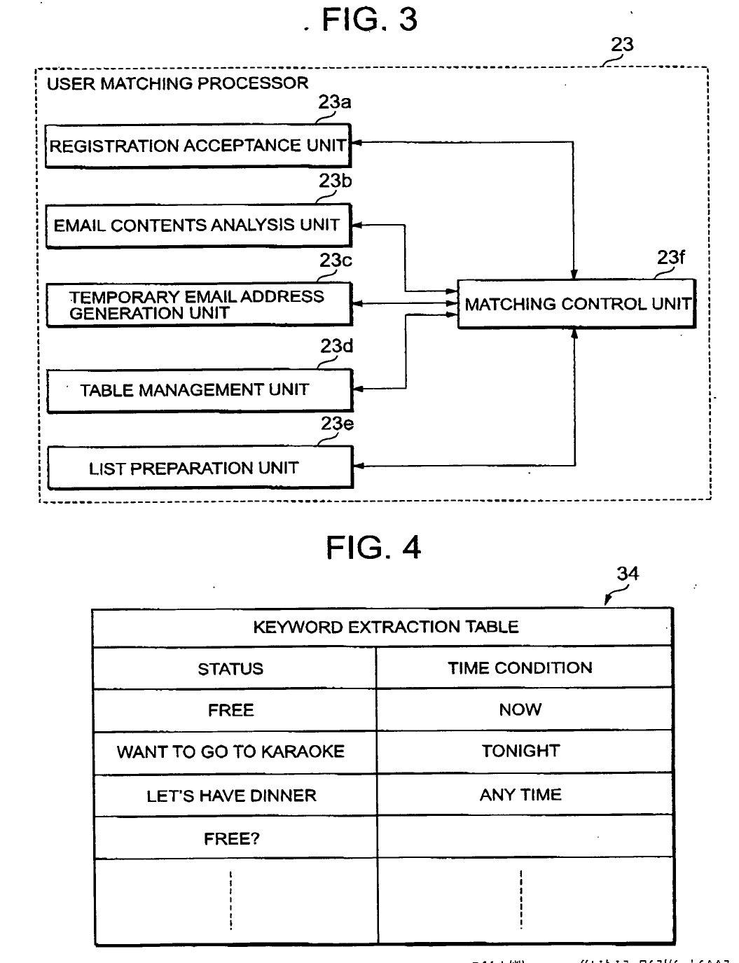

FIG. 3 is a detailed diagram for explaining the user matching processor 23. The user matching processor 23 includes a registration acceptance unit 23a, an email contents analysis unit 23b, a temporary email address generation unit 23c, a table management unit 23d, a list preparation unit 23e and a matching control unit 23f.

The registration acceptance unit 23a accepts a user registration application submitted by the user A or B who employs either the cellular phone 10a or 10b to receive a user matching service. The user registration can be applied by using a predetermined registration form provided by the user matching server 20.

To call for the registration form using the cellular phone 10a or 10b, a menu item that corresponds to the email address of the user matching server 20 is prepared in advance on the cellular phone 10a or 10b. By selecting this item, the registration form can be displayed on the screen of the cellular phone 10a or 10b.

Either this, or the email address of the user matching server 20 may be presented in a newspaper or a magazine, and when this address of the user matching server 20 is accessed by the cellular phone 10a or 10b, a predetermined registration form can be displayed on the screen of the cellular phone 10a or 10b.

The email contents analysis unit 23b analyzes the contents of an email sent by the user A or B, and determines a registration condition or a request condition that includes, at the least, a status and a time condition. That is, as shown in FIG. 2, assuming that the user A, who completed the user registration, has used the cellular phone 10a to transmit an email to the user matching server 20, requesting the registration of, for example, “I'm free”, a registration condition that includes the status “free” and the time condition “now” is identified based on the contents of the email.

Furthermore, assuming that the user B, who completed the user registration, has used the cellular phone 10b to transmit an inquiry email to the user matching server 20 consisting of, for example, “Are you free?”, the email contents analysis unit 23b identifies a request condition that includes the status “free?” and the time condition “now”.

The email contents analysis unit 23b can identify a registration condition or a request condition by referring, for example, to a keyword extraction table 34, shown in FIG. 4, that is provided for the database 30. In the keyword extraction table 34 in FIG. 4, multiple keywords, such as “free”, “want to go to karaoke”, “let's have dinner” and “free?”, are registered as statuses, and multiple keywords, such as “now”, “tonight” and “any time”, are registered as time conditions.

Instead of referring to the keyword extraction table 34, the email contents analysis unit 23b may employ a predetermined program that includes these statuses and time conditions to identify the registration condition or the request condition described above.

The temporary email address generation unit 23c prepares an available temporary email address in accordance with the use limiting condition for the user that is accepted by the registration acceptance unit 23a. There are various use limiting conditions, and in this embodiment, for convenience sake, a use period is employed.

The temporary email address generation unit 23c examines temporary email addresses entered in the status table 32 so that a temporary email address to be created does not overlap temporary email addresses entered in the status table 32.

The table management unit 23d performs the addition, the changing and the deletion of information entered in the account table 31, the status table 32 and the temporary email address table 33, based, at the least, on information accepted by the registration acceptance unit 23a, information analyzed by the email contents analysis unit 23b, and the temporary email addresses created by the temporary email address generation unit 23c.

The list preparation unit 23e examines the status table 32 to find user IDs for which the status “free” and the time condition “now” are entered so as to find matching statuses “free?” and time conditions “now”. Then, in accordance with the temporary email address table 33, a list 1000 of temporary email addresses corresponding to the matched user IDs is prepared. In this case, the use periods in the temporary email address table 33 are referred to, and temporary email addresses for user IDs for which the use periods have expired are not entered in the list.

The matching control unit 23f employs a predetermined control program to control the operations of the registration acceptance unit 23a, the email contents analysis unit 23b, the temporary email address generation unit 23c, the table management unit 23d and the list preparation unit 23e.

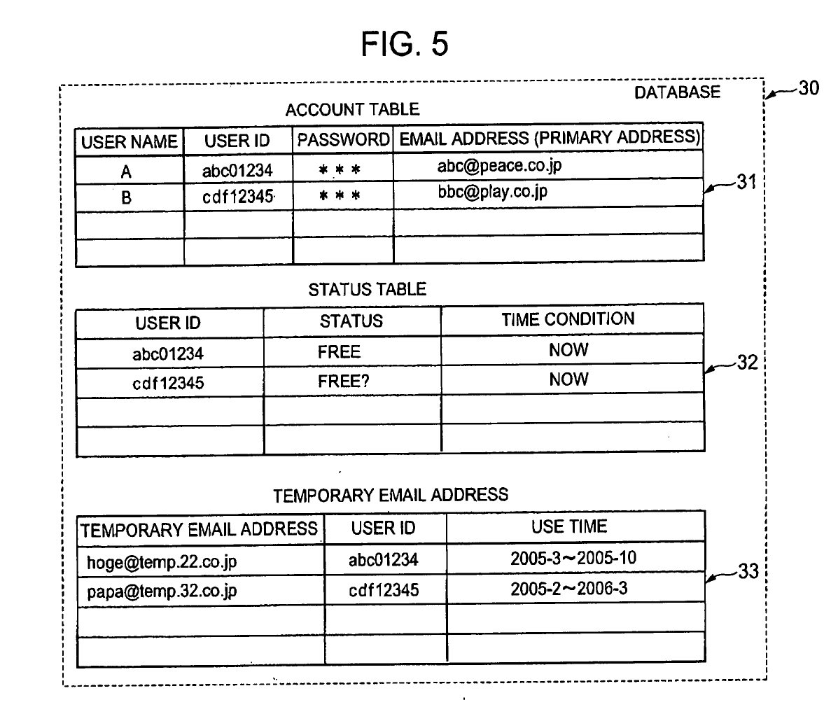

FIG. 5 is a detailed diagram for explaining the database 30. In the account table 31 of the database 30, user information for users who have completed user registrations is registered by the table management unit 23d. At the least, a user name, a user ID, a password and an email address (a primary email address) are entered. In FIG. 5, the user information for the user A and user B is registered in the account table 31.

In the status table 32, at the least, the user IDs of the user A and user B and the statuses and the time conditions analyzed by the email contents analysis unit 23b are registered. In the temporary email address table 33, registered for each user are, at the least, a temporary email address generated by the temporary email address generation unit 23c, a user ID and a use period, which is a use limiting condition.

The operation of the user matching system will now be explained.

(User Registration)

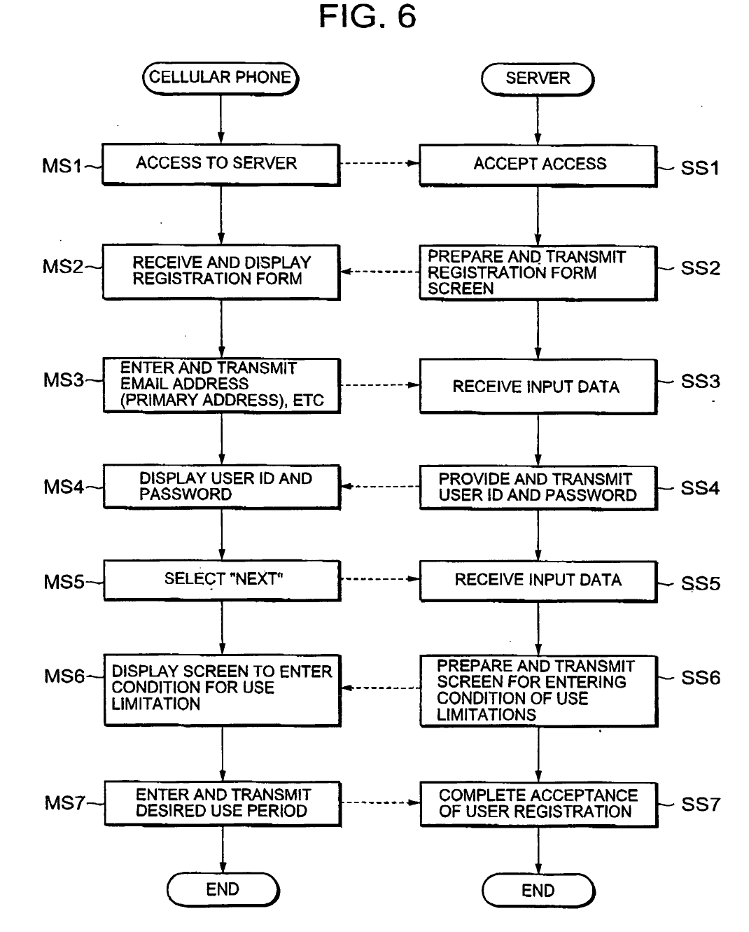

While referring to FIG. 6, an explanation will now be given for the user registration performed by the user A.

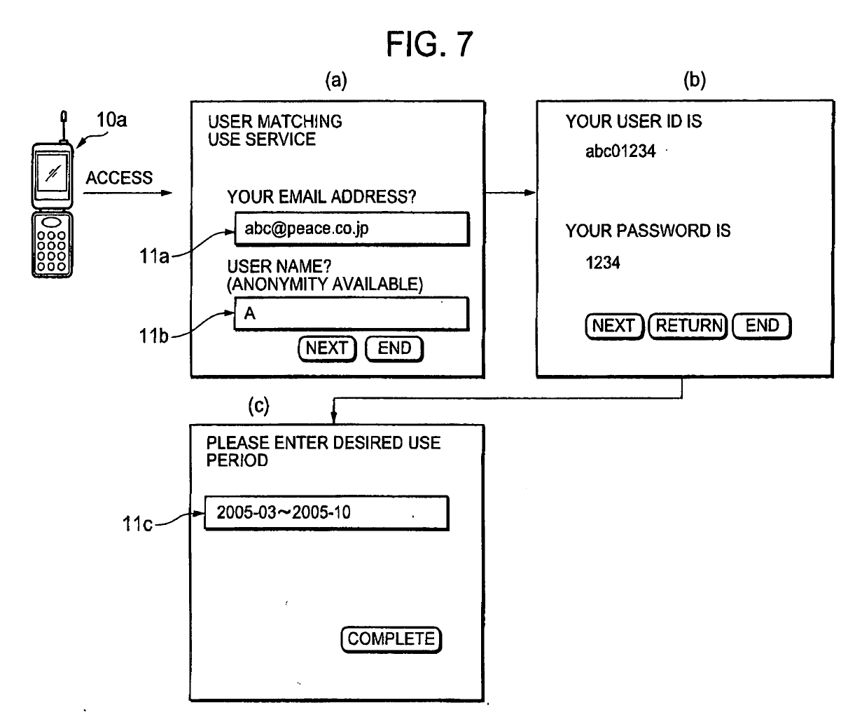

The user A, who uses the cellular phone 10a, accesses the user matching server 20 (step MS1), and the user matching server 20 accepts the access (step SS1) and creates and transmits a registration form screen (step SS2). Then, the cellular phone 10a receives the registration form screen and displays the predetermined registration form shown in FIG. 7 (step MS2).

As described above, a menu item that corresponds to the email address of the user matching server 20 is provided for the cellular phone 10a, and is selected in order to call up the predetermined registration form.

The user A enters, in an input column 11a, as indicated by the reference number (a), in FIG. 7, the email address (the primary address) allocated previously to the cellular phone 10a, enters a user name (anonymity available) in an input column 11b, and selects “Next” to transmit an email (step MS3). The user matching server 20 receives these input data (step SS3) and provides a user ID and a password that it transmits (step SS4), and as indicated by the reference number (b) in shown in FIG. 7, the registration acceptance unit 23a displays the user ID and the password that have been allocated (step MS4). When the user desires to cancel the user registration on the screen as indicated by the reference number (a) in FIG. 7, the user need only select “End”.

The user ID and the password are automatically assigned by the user matching server 20, and are employed when the user matching server 20 accepts an alteration of the contents of an email transmitted by the user, or abandons an email received from the user.

The user ID and the password may be arbitrarily designated by the user. However, while taking into consideration the management of users and the convenience of the user, it is efficient for the user matching server 20 to automatically assign a user ID and a password. Because user IDs, especially, may overlap when other users have already been registered, the exchange of emails with the user matching server 20 must be performed frequently until an unused user ID is assigned.

Furthermore, when the user discovers on the screen(b) in FIG. 7 that the email address is incorrect, the user need only select “Return” on the screen(a) in FIG. 7 and enter the correct email address. When the user desires to cancel the user registration on the screen(b) in FIG. 7B, the user need only select “End”.

When “Next” is selected on the screen(b) in FIG. 7 (step MS5), the user matching server 20 receives the input data (step SS5) and creates and transmits a screen to permit the user to enter a use limiting condition (step SS6). Then, on the cellular phone 10a, a screen(c) shown in FIG. 7 is displayed for the entry of a use limiting condition (step MS6). The user enters a desired period in an input column 11c wherein a use period is entered (step MS7).

When the user desires to employ the user matching service during a period of, for example, from March 2005 to October 2005, the user need only enter, for example, March 2005 to October 2005. Or, when a desired use period is, for example, from Mar. 10, 2005 to Oct. 10, 2005, only Oct. 3, 2005 to Oct. 10, 2005 need be entered. The period input form is not limited to this, and an arbitrary form can be employed. Further, period choices may be displayed by selecting the input column 11c, and a period may be selected.

After the desired use period has been entered and “Complete” has been selected, the registration acceptance unit 23a of the user matching processor 23 of the user matching server 20 completes the acceptance of the user registration application submitted by the user A (step SS7).

When the registration acceptance unit 23a has accepted the user registration, in the account table 31 of the database 30, the table management unit 23d registers, at the least, a user name, a user ID, a password and an email address (a primary email address), which are the user information for the user A who has completed the user registration.

The user registration application for the user B is accepted in the same manner, and in the account table 31 of the database 30, the user management unit 23d registers, at the least, a user name, a user ID, a password and an email address (a primary email address), which are the user information for the user B who has completed the user registration.

(Schedule Registration Processing)

The schedule registration processing will now be described. The schedule registration processing is processing during which the hobby and the interests of the user are arbitrarily registered after the user registration has been completed and accepted at step SS7 in FIG. 6. In the following explanation, assume that the user A has completed the user registration using the above described procedures and is to provide schedule registration data.

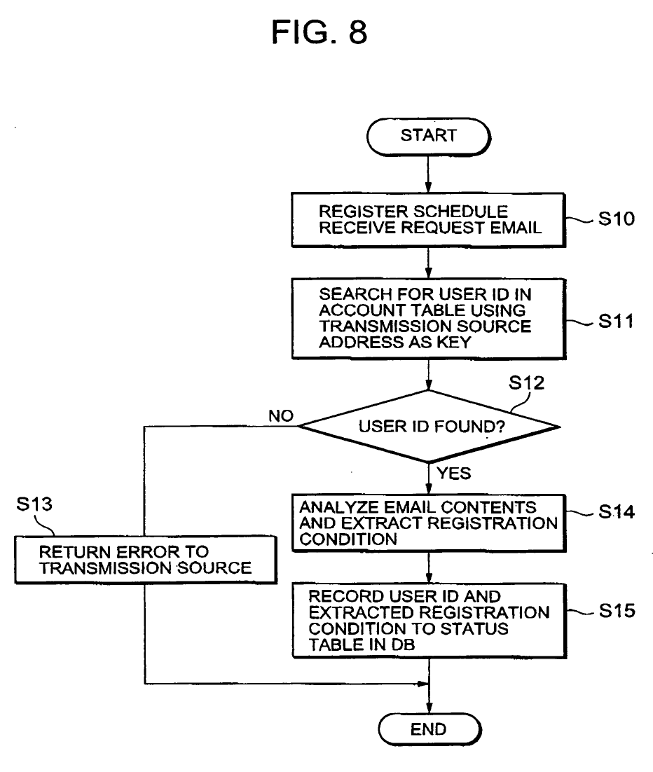

First, as shown in FIG. 8, when the user A has used the cellular phone 10a to transmit an email to the user matching server 20 requesting the registration, in the user matching server 20, of the contents “I'm free”, the email transmitter/receiver 22 receives this email via the Internet 41 and through the communication unit 21 (step S10). Then, the received email is temporarily stored in the table management unit 23d, or in a memory (not shown).

At this time, the registration acceptance unit 23a examines the email address (the primary email address) of the transmission source (user A) registered in the account table 31 of the database 30, for example, and searches for the user ID using the email address (the primary email address) as a key (step S11).

A check is performed to determine whether the user ID of the user A is present in the account table 31 of the database 30 (step S12). When the user ID is not present, it is assumed that user registration by the user A has not yet been performed, and in accordance with an instruction issued by the matching control unit 23f, the email transmitter/receiver 22 returns an error message email requesting that the user A complete the user registration (step S13).

When the user ID of the user A has already been registered in the account table 31 of the database 30, the email contents analysis unit 23b of the user matching processor 23 analyzes the contents of the email and extracts a registration condition (step S14). That is, status “free” and time condition “now” are extracted from the contents of the email and are regarded as registration conditions.

When the email contents analysis unit 23d obtains the status and the time condition by performing the analysis, the table management unit 23d records the user ID and the extracted registration conditions in the status table 32 (step S15). That is, the user ID, status “free” and time condition “now” are entered in the status table 32.

In this manner, each time an email requesting registration is received from a user who has completed the user registration, the email contents analysis unit 23b extracts the status and the time condition from the contents. Then, after the email contents analysis unit 23b has performed the analysis of the email, the table management unit 23d enters the user ID, the status and the time condition for each email in the status table 32

(User List Acquisition Processing)

The user list acquisition processing will now be described. In the following explanation, assume that the user B has issued an inquiry seeking a user who has the same hobby or interests.

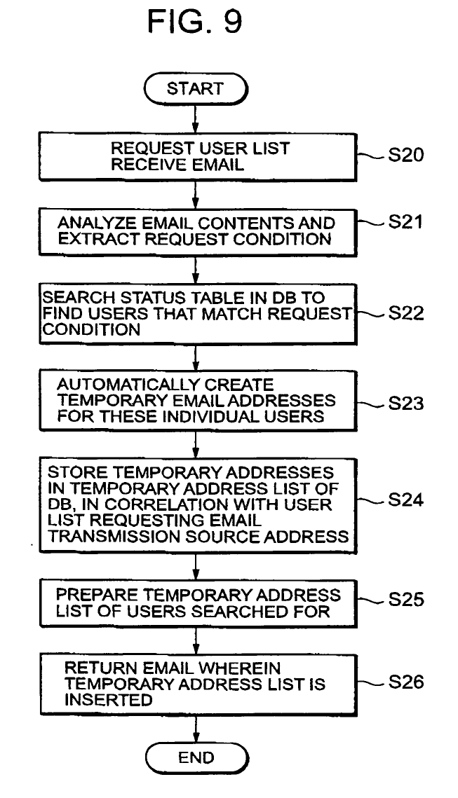

First, as shown in FIG. 9, when the user B has used the cellular phone 10b to transmit a user list request email, the email transmitter/receiver 22 receives this email in the above described manner (step S20). The received email is also temporarily stored in the table management unit 23d, or in a memory (not shown). In this case, an inquiry email containing the contents, “Are you free?” is transmitted by the cellular phone 10b of the user B.

At this time, as described above, the registration acceptance unit 23a examines, for example, the email address (the primary email address) registered in the account table 31. When the email address (the primary email address) indicating the email transmission source (the user B) is present in the account table 31, it is assumed that user registration has already been performed.

When the registration of the user B has not yet been performed, as described above, in accordance with an instruction issued by the matching control unit 23f, the email transmitter/receiver 22 transmits an error message email requesting that the user B complete the user registration.

When the user B has already been registered, the user email analysis unit 23b of the user matching processor 23 analyzes the contents of the email and extracts a request condition, as at least one matching request (step S21). That is, the status “free?” and the time condition “now” are extracted, and a request condition is established that includes the status “free?” and the time condition “now”.

When the email contents analysis unit 23b has, by analysis, obtained as the request conditions the status and the time conditions, the table management unit 23d enters the user ID of the user B, the status and the time condition in the status table 32 of the database 30.

Following this, the table management unit 23d searches the status table 32 of the database 30 to find users who match the request conditions submitted by the user B (step S22). That is, the table management unit 23d searches the status table 32 to find user IDs for which the status and the time condition that are entered correspond to the status “free?” and the time condition “now”.

When users who match the request condition submitted by the user B are found, in accordance with an instruction provided by the matching control unit 23f, the temporary email address generation unit 23c automatically generates a temporary email address for the user ID of each user that matches the request conditions submitted by the user B (step S23).

When the temporary email addresses have been automatically generated, the table management unit 23d stores (registers) the temporary email addresses in the temporary email address table 33 of the database 30, in correlation with the transmission source email address of the user B (step S24).

Next, in accordance with an instruction issued by the matching control unit 23f, the list preparation unit 23e prepares a list of the temporary email addresses of the users who match the request conditions submitted by the user B (step S25). In this case, the use periods entered in the temporary email address table 33 are referred to, and user IDs for which the use period has expired are not selected for the list.

As a result, the email transmitter/receiver 22 transmits, to the cellular phone lob of the user B, the list 1000 of persons who are free, which is prepared by the list preparation unit 23e and which includes the temporary email addresses of multiple users (step S26).

Since the temporary email addresses prepared in accordance with the use limiting conditions of the individual users are entered in the list 1000 of persons who are free, the anonymity of the email addr--esses of these users can be maintained.

(Processing for Transmitting an Email to a Temporary Email Address)

An explanation will now be given for the processing for transmitting an email to a temporary email address.

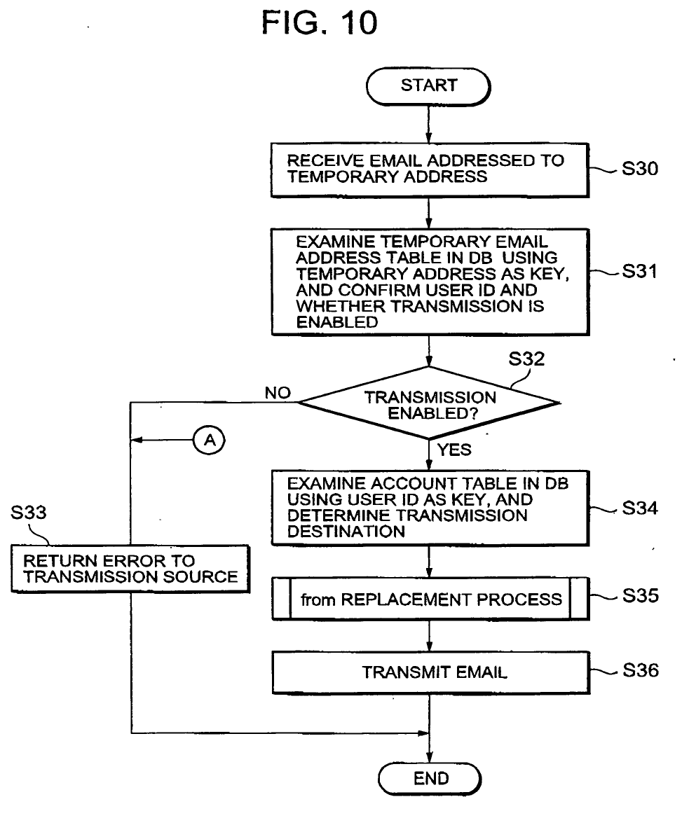

First, as shown in FIG. 10, upon receiving the list of persons who are free, the user B selects the temporary email address of one of the users on the list and transmits to the user matching server 20 an email to that effect that is received by the email transmitter/receiver 22 (step S30).

In the same manner as is as described above, the received email is temporarily stored in the table management unit 23d, or in a memory (not shown).

When the user B has selected a desired user, the selected temporary email address can be used as the destination for the email, and a message expressing, for example, the thought, “Let's have a good time”, can be inserted in the email to be transmitted.

Assume that the temporary email address selected by the user B is the user A and the email from the user B is received. In accordance with an instruction issued by the matching control unit 23f, the table management unit 23d identifies the user ID corresponding to the temporary email address of the user A that has been selected by the user B in the temporary email address table 33, and determines whether the transmission of an email to the user A is enabled (step S31).

That is, the use period, for example, for the temporary email address of the user A is examined to determine whether the transmission of an email to the user A is enabled (step S32). When the transmission of an email to the user A is not enabled, an error message is transmitted to the user B indicating that the use period for the temporary email address of the user A has expired (step S33).

When the transmission is enabled, the table management unit 23d searches for the email address (the primary email address) using, as a key, the user ID of the user A that is registered in the account table 31 of the database 30, and designates the user A as the transmission destination (step S34).

Thereafter, the “from” replacement processing for regarding the email address (the primary email address) of the user B as a temporary email address is performed (step S35). Then, an email including a message, containing, for example, “Let's have a good time”, is transmitted by the email transmitter/receiver 22 to the user A (step S36). In this case, since the temporary email address is used as the email address of the user B, the transmission source, the anonymity of the user B can be maintained, and the email address of the user A is the primary email address.

After the email of the user B has been transmitted to the user A, the table management unit 23d may add information such as “planned” to the temporary email address or the user ID of the user A of the temporary email address table 33. In this case, this information may be represented as a flag.

When the flag representing the contents of “planned” is added to the temporary email address or the user ID of the user A in the temporary email address table 33, upon receiving the same kind of inquiry email from another users the list preparation unit 23e does not select the temporary email address of the user A for inclusion in a list 1000 of persons who are free.

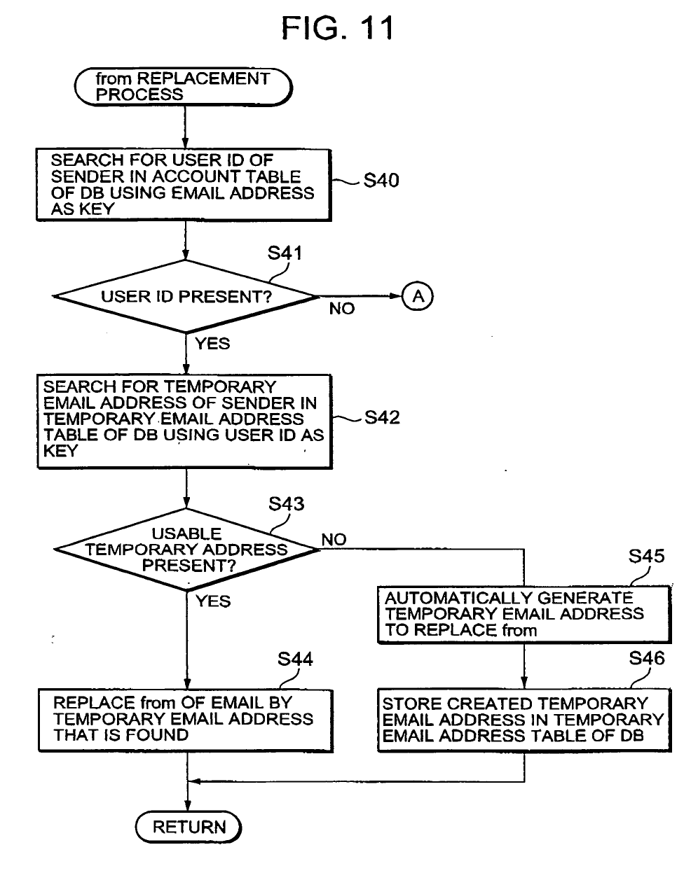

In the “from” replacement processing at step S35, first, the table management unit 23d searches for the user ID of the user B in the account table 31 of the database 30 using, as a key, the email address (the primary email address) of the user B (step S40 in FIG. 11).

A check is then performed to determine whether the user ID of the user B is present in the account table 31 (step S41). When the user ID of the user B is not present, program control is shifted to step S33 in FIG. 10 and an error message containing, for example, “Please perform user registration”, is transmitted to the user B.

When the user ID of the user B is present, the table management unit 23d searches for the temporary email address of the user B in the temporary email address table 33 of the database 30, while using the user ID of the user B as a key (step S42).

Further, during the search for the temporary email address of the user B, a check is performed to determine whether a usable temporary email address is present in the temporary email address table 33 (step S43). When such a temporary email address is present, the email address in “from”, which is the transmission source (user B), is replaced by the temporary email address (step S44).

When no usable temporary email address is present in the temporary email address table 33, in accordance with an instruction issued by the matching control unit 23f, the temporary email address generation unit 23c automatically generates a temporary email address corresponding to the user ID of the user B and replaces the email address in “from”, which indicates the transmission source (user B), with the temporary email address (step S45).

When the temporary email address of the user B is automatically generated, the table management unit 23d stores (registers) this temporary email address in the temporary email address table 33 of the database 30, in correlation with the user ID of the user B (step S46).

As described above, in this embodiment, when a matching condition is accepted, a memory is searched to find a user ID that corresponds to an email address for the portable terminal that is the access source, and a temporary email address corresponding to the user ID is generated. Then, the temporary email address is registered in the memory in correlation with the corresponding user ID, and in accordance with the matching conditions, matching is performed for the user ID that is found. In accordance with the matching results, the temporary email address stored in the memory is employed to exchange an email with the portable terminal at the access source. Therefore, the users can exchange email, using temporary email addresses, without being aware of the temporary email addresses and without any labor being required.

Furthermore, in this embodiment, since the use limiting condition is employed as a use period, when this period has expired, the use of the temporary email address is disabled or abandoned, regardless of whether the user is aware of the temporary email address, and the user need not manage it. Therefore, the usability of the email function of the cellular phone 10a or 10b can be improved.

In the explanation for this embodiment, the email contents analysis unit 23b has identified status “free” and time condition “now” by performing an analysis of the email that indicates a predetermined registration condition, or has identified the status “free?” and the time condition “now” by performing an analysis of an email that indicates a predetermined request condition. However, the present invention is not limited to this example. Various other registration conditions or request conditions can be employed, and statuses such as “want to go to karaoke” and “let's have dinner”, and time conditions such as “tonight” and “any time” may be employed.

Further, not only the use period, but also the number of reception times can be employed as the use limiting condition. Also in this case, regardless of whether the user is aware of it, the use of the temporary email address is disabled or abandoned when a designated number of reception times have been recorded, and as described above, the user need not manage the temporary email address. Thus, the usability of the email function can be improved.

The present invention can also be applied for a general communication system that employs portable terminals having email functions.

What is claimed is:

1. A user matching server, for controlling portable terminals and perform the matching of users, comprising:
a storage unit, for storing email addresses of users in correlation with user IDs;
an acceptance unit, for accepting at least one matching condition received by email from a portable terminal;
a search unit, for, when at least one matching condition is received by the acceptance unit, searching the storage unit to find a user ID corresponding to an email address for a portable terminal that is an access source for the matching condition;
a generation unit, for, when the search unit has found the user ID, generating a temporary email address corresponding to the user ID;
a registration unit, for registering, in the storage unit, the temporary email address generated by the generation unit in correlation with the user ID corresponding to the temporary email address;
a matching unit, for referring to the storage unit and performing matching, in accordance with the matching condition accepted by the acceptance unit, for the user ID found by the search unit; and
an email communication unit, for, in accordance with the matching results obtained by the matching unit, employing the temporary email address stored in the storage unit to exchange email with the portable terminal at the access source.

2. A user matching server as set forth in claim 1, wherein a use period is designated for the temporary email address registered by the registration unit.

3. A user matching server as set forth in claim 1, further comprising:
a matching condition storage unit, for storing paired matching conditions.

4. A user matching method, for a server that controls portable terminals and performs the matching of users, comprising:
accepting at least one matching condition transmitted by email by a portable terminal;
when the matching condition is accepted, examining a memory provided for the server wherein email addresses of users are stored in correlation with user IDs, and of searching for a user ID corresponding to an email address of a portable terminal that is an access source for the at least one matching condition;
when the user ID is found, generating a temporary email address corresponding to the user ID;
registering, in the memory, the temporary email address generated in correlation with the user ID corresponding to the temporary email address;
referring to the memory and of performing matching for the user ID found in accordance with the matching condition accepted; and
in accordance with the matching results obtained employing the temporary email address stored in the memory to exchange an email with the portable terminal at the access source.

5. A user matching method as set forth in claim 4, further comprising:
designating a use period for the temporary email address registered.

6. A user matching method as set forth in claim 4, further comprising storing paired matching conditions.

7. A user matching program, executable by a computer of a server that controls portable terminals and performs the matching of users, that permits the computer to perform;
accepting at least one matching condition transmitted by email by a portable terminal;
when the matching condition is accepted, examining a memory provided for the server wherein email addresses of users are stored in correlation with user IDs, and of searching for a user ID corresponding to an email address of a portable terminal that is an access source for the at least one matching condition;
when the user ID is found, generating a temporary email address corresponding to the user ID;
registering, in the memory, the temporary email-address generated in correlation with the user ID corresponding to the temporary email address;
referring to the memory and of performing matching for the user ID found in accordance with the matching condition accepted; and
in accordance with the matching results obtained employing the temporary email address stored in the memory to exchange an email with the portable terminal at the access source.

8. A user matching program as set forth in claim 7, which permits the computer to further perform:
designating a use period for the temporary email address registered.

9. A user matching program as set forth in claim 7, which permits the computer to further perform storing paired matching conditions.
